(19) United States
(12) Patent Application Publication
(10) Pub. No.: US 2012/0081008 A1
(43) Pub. Date: Apr. 5, 2012

(54) CONTROL CIRCUIT MODULE OF LIGHT-EMITTING DIODE LAMP

(75) Inventors: Ke-Horng CHEN, Hsinchu City (TW); Shao-Wei Chiu, Hsinchu City (TW); Chun-Chieh Kuo, Hsinchu City (TW); Yung-Lin Chen, Hsinchu City (TW); Shih-Ping Tu, Hsinchu City (TW)

(73) Assignee: Anwell Semiconductor Corp., Hsinchu City (TW)

(21) Appl. No.: 13/164,918

(22) Filed: Jun. 21, 2011

(30) Foreign Application Priority Data
Oct. 5, 2010 (TW) 099133789

(51) Int. Cl. H05B 37/02

(52) U.S. Cl. 315/122; 315/192

(57) ABSTRACT

The present invention relates to a control circuit module of light-emitting diode (LED) lamp, which comprises: a AC to DC element, for transferring mains AC power to DC power; a plurality of groups of LED; a plurality of switches, corresponding to the number of the groups of LED, for controlling to turn on/off the each group; a linear voltage regulator, for cutting the DC power from the AC to DC element to a plurality of voltage sections; a switch selector, for selecting to open/close the switches according to the voltage sections from the linear voltage regulator; a current selector, for capturing available current sections from the voltage sections of the linear voltage regulator; and a LED current setup device, for controlling the current sections to open/close the plurality of switches by a user according to the LED current setup device and the current selector.

### TECHNICAL FIELD

The present invention relates to a control circuit module of light-emitting diode (LED), and more particularly, to a control circuit module with high power factor and high-efficiency to control the plurality of groups of LED corresponding to the same groups of switches, and switch the DC current form the AC to DC element to the plurality of current sections. Subsequently, the control module may control the open and close of the plurality of switches according to each current section, and the plurality of switches control the plurality of groups of LED to turn on one group of LED, a part of groups of LED or all groups of LED, and control the same light time of each group of LED in the plurality of groups of LED in a period so as to achieve the purpose of the equal brightness of the LED lamp and balance the useful life of the plurality of groups of LED.

### TECHNICAL BACKGROUND

People develop a variety of technologies to create necessary products for people life, and the lighting equipment is a great key. Before the light was invented, the entire job can not be performed after sunset. However, all manufactures and technology researches can be performed in the night after the light equipment is invented. Thereby, the light equipment is very important invention in the recent technology.

In recent light equipment, visual perception affects the design and regulation of the entire light equipments. Moreover, the purpose of the light equipment is different with the general optical system. Some people need a light lamp with higher power to apply in the high-luminance occasion, and some people need a better light guiding device to obtain the equal brightness. Nowadays, the earth is confronted with the problem of inadequate resources, and the light lamp seen the purpose of the environment protection, decreases the power of the light lamp to save the electricity, and maintains the luminance. Therefore, the study key of the light lamp with green energy is how to increase the luminance, the equal brightness, the useful life, decrease the production cost, and save the electricity, so as to take place of the tungsten lamp, sun lamp and the like. The new control circuit module of LED lamp provided by the present invention may make the LED lamp with the new control circuit module became the mainstream of the market.

### TECHNICAL SUMMARY

In view of the foregoing, according to one aspect of the present embodiment, the present invention provides a control circuit module of light-emitting diode (LED) lamp, which is used for designing a control circuit module with high power factor and high-efficiency to control the plurality of groups of LED corresponding to the same groups of switches, and switch the DC current form the AC to DC element to the plurality of current sections. Subsequently, the control module may control the open and close of the plurality of switches according to each current section, and the plurality of switches control the plurality of groups of LED to turn on one group of LED, a part of groups of LED or all groups of LED, and control the same light time of each group of LED in the plurality of groups of LED in a period so as to achieve the purpose of the equal brightness of the LED lamp and balance the useful life of the plurality of groups of LED.

According to another aspect of the present embodiment, a detect shutdown point is set in the control circuit module, and the detect shutdown point is used to enable circuit shutdown, over-temperature protection and current value of short protection for avoiding the damage of the control circuit module and the LED because of the abnormal large current.

In one embodiment, the present disclosure provides a control circuit module of light-emitting diode (LED) lamp with detect points of Vcc, FF, Iset (LED current setup), LD, SW1, SW2, SW3 and a ground point, and the control circuit module comprises: a AC to DC element, for transferring mains AC power to DC power; a plurality of groups of LED, wherein each group comprises a plurality of serial connected LED/parallel connected LED; a plurality of switches, corresponding to the number of the groups of LED, for controlling to turn on/off the each group; a linear voltage regulator, for cutting the DC power from the AC to DC element to a plurality of voltage sections; a switch selector, for selecting to open/close the switches according to the voltage sections from the linear voltage regulator; a current selector, for capturing available current sections from the voltage sections of the linear voltage regulator; and a LED current setup device, for controlling the current sections to open/close the plurality of switches by a user according to the LED current setup device and the current selector.

Perfectly, the control circuit module of LED lamp further comprises a feedforward compensation circuit.

Perfectly, the control circuit module of LED lamp further comprises an over-temperature protection circuit.

Perfectly, the control circuit module of LED lamp further comprises a detect shutdown point, which is used to enable circuit shutdown, over-temperature protection and current value of short protection.

Perfectly, the detect shutdown point is simultaneity connected with the plurality of switches, the feedforward compensation circuit and the LED current setup device.

Perfectly, an operational amplifier is located between the detect shutdown points and the LED current setup device.

Perfectly, the plurality of switches consists of MOSFET.

Perfectly, the plurality of groups of LED turn on one group of LED, a part of group of LED or all group of LED according to the set of the LED current setup device.

Perfectly, the control circuit module of LED lamp further comprises the AC to DC element consists of a full-bridge rectifier.

Perfectly, an input terminal of the AC to DC element is connected to one of a dimmer consisting of a Triac, a PWM or a linear dimmer to adjust the light.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1A illustrates it is used for capturing available current sections from the output voltage sections of the AC to DC element according to a first embodiment of the present invention;

FIG. 1B illustrates a control circuit module of LED lamp according to the first embodiment of the present invention;

FIG. 2A illustrates it is used for capturing available current sections from the output voltage sections of the AC to DC element according to a second embodiment of the present invention;

FIG. 2B illustrates a control circuit module of LED lamp according to the second embodiment of the present invention;

FIG. 3A illustrates it is used for capturing available current sections from the output voltage sections of the AC to DC element according to a third embodiment of the present invention;

FIG. 3B illustrates it is used for capturing available current sections from the output voltage sections of the AC to DC element according to a fourth embodiment of the present invention;

FIG. 3C illustrates a control circuit module of LED lamp according to the third embodiment of the present invention;

FIG. 4 illustrates a control circuit module of LED lamp according to the fourth embodiment of the present invention;

FIG. 5A illustrates it is used for capturing available current sections from the output voltage sections of the AC to DC element according to a fifth embodiment of the present invention; and

FIG. 5B illustrates a control circuit module of LED lamp according to the fifth embodiment of the present invention.

### DESCRIPTION OF THE EXEMPLARY EMBODIMENTS

For your esteemed members of reviewing committee to further understand and recognize the fulfilled functions and structural characteristics of the disclosure, several exemplary embodiments cooperating with detailed description are presented as the follows.

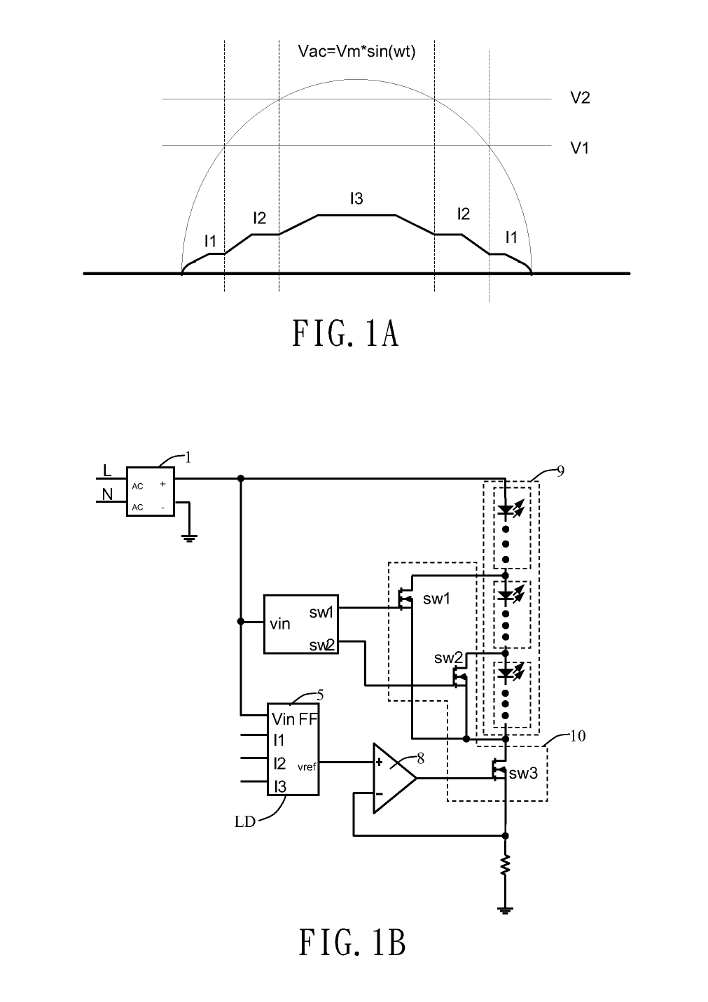

FIG. 1B is a schematic diagram showing a control circuit module of light-emitting diode (LED) lamp according to a first embodiment of the present invention. The basic circuit control structure of the present invention in FIG. 1B use threes groups of switch (SW1, SW2, SW3) to control the three groups of light-emitting diode (LED), and the control current section shown in FIG. 1A is divided to section (I₁, I₂, I₃). In the section I₁, a first group of LCD is turn on by setting a LCD current setup device 5 and a reference current from an operational amplifier 8; in the section I₂, the first group of LCD and a second group of LCD are simultaneity turn on; in the section I₃, the first and second groups of LCD and a third group of LCD are simultaneity turn on. The cycle of I₁→I₂→I₃→I₂→I₁ in the current section will be continuously recycled, so all the groups of LCD may be turn on or off during the cycle.

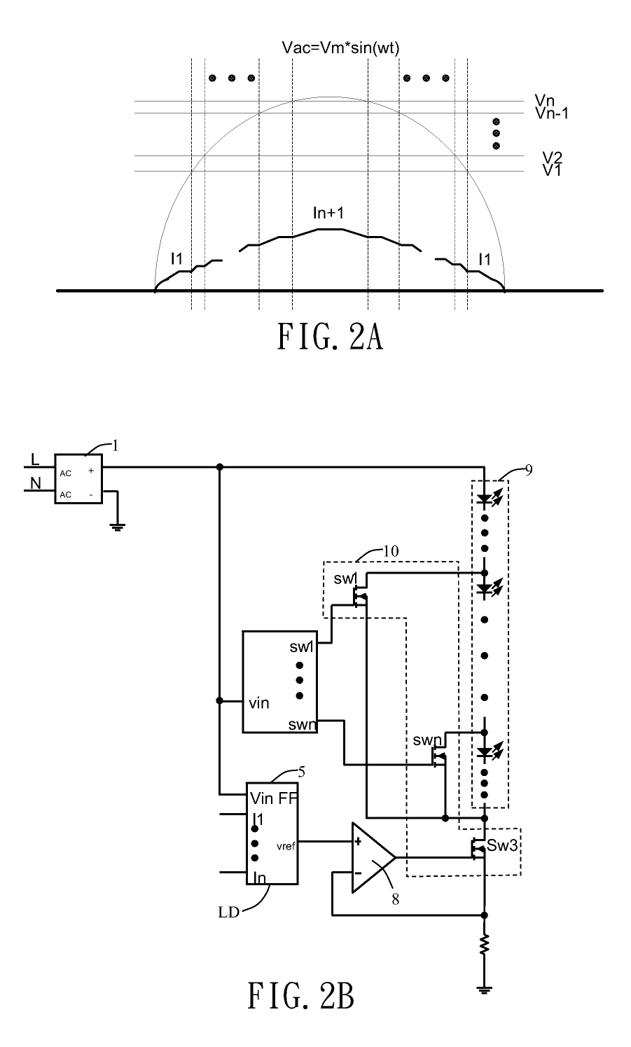

As shown in FIG. 2B, a distinction between the FIGS. 2B and 1B is that the switches, the current sections and the group number of LCD adopted by the present invention is not limited in the embodiment, for example, the three groups of LCD disclosed by the FIG. 1A and 1B. Therefore, the present invention may apply to more than two groups of circuit control mode. The voltage section and the current section are the more distinguished, and the power factor and the efficiency are higher.

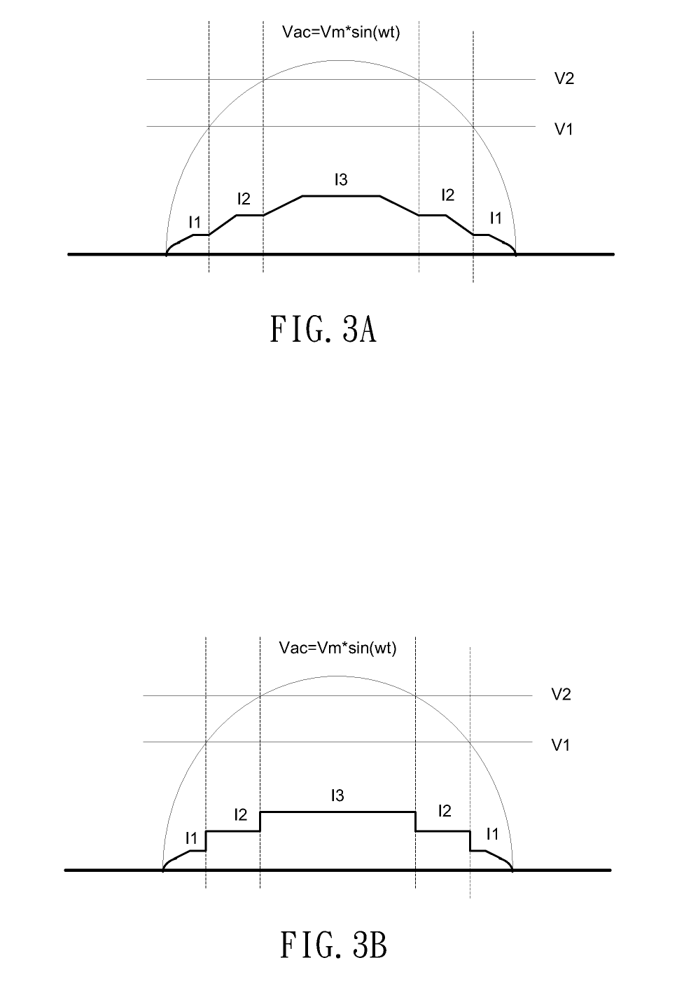

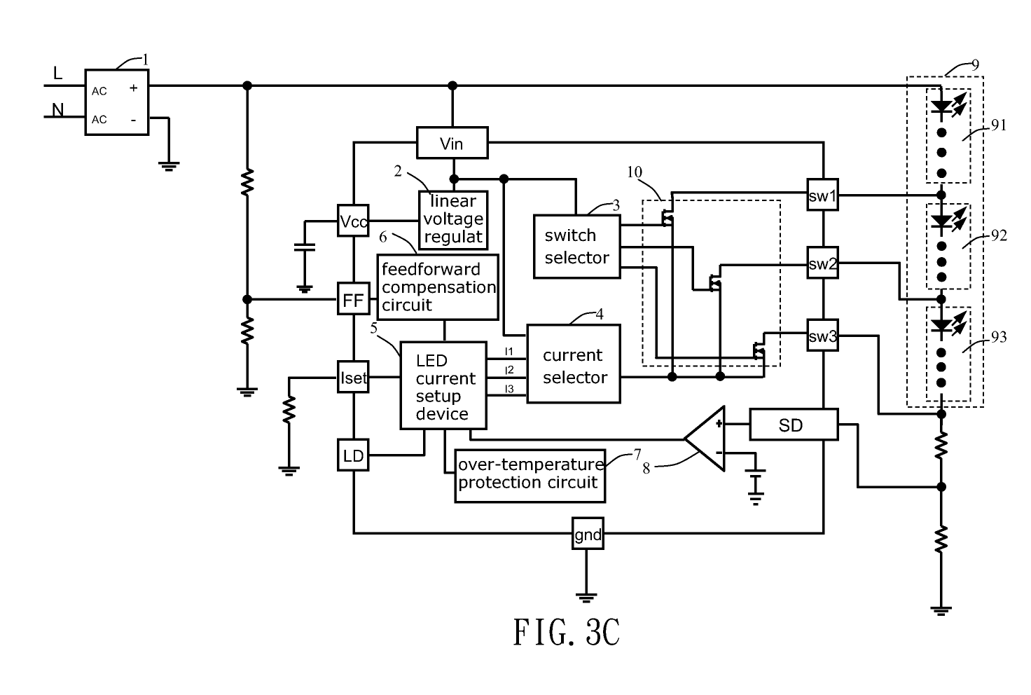

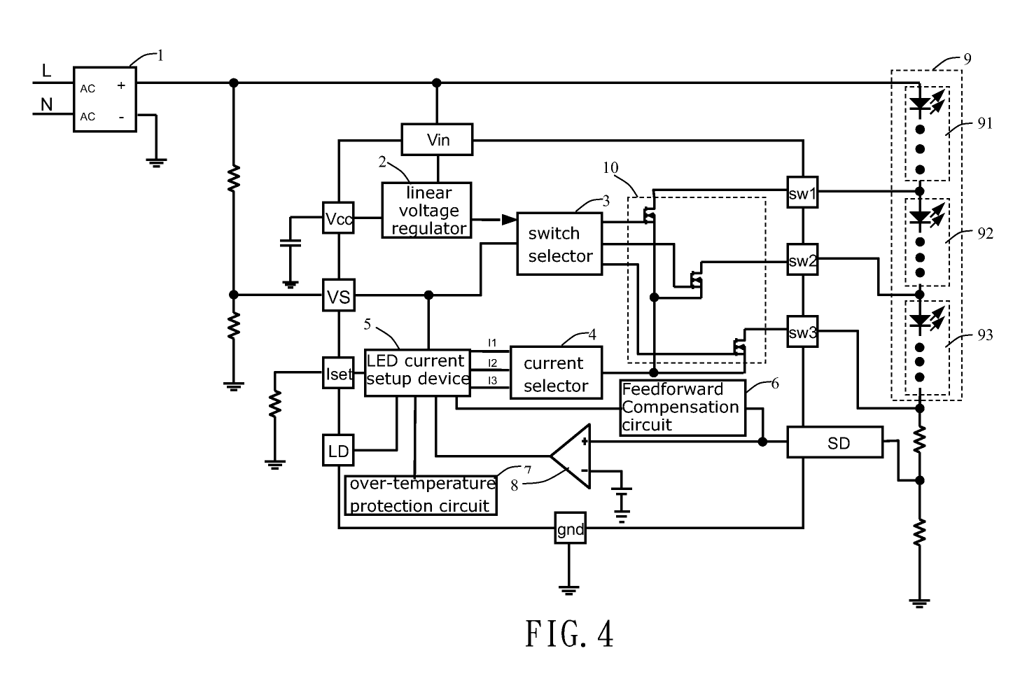

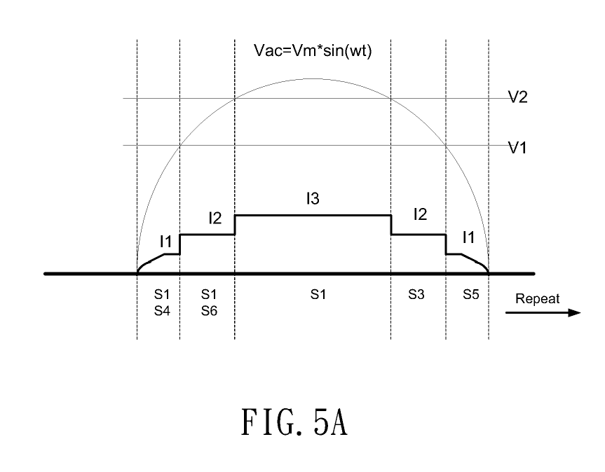

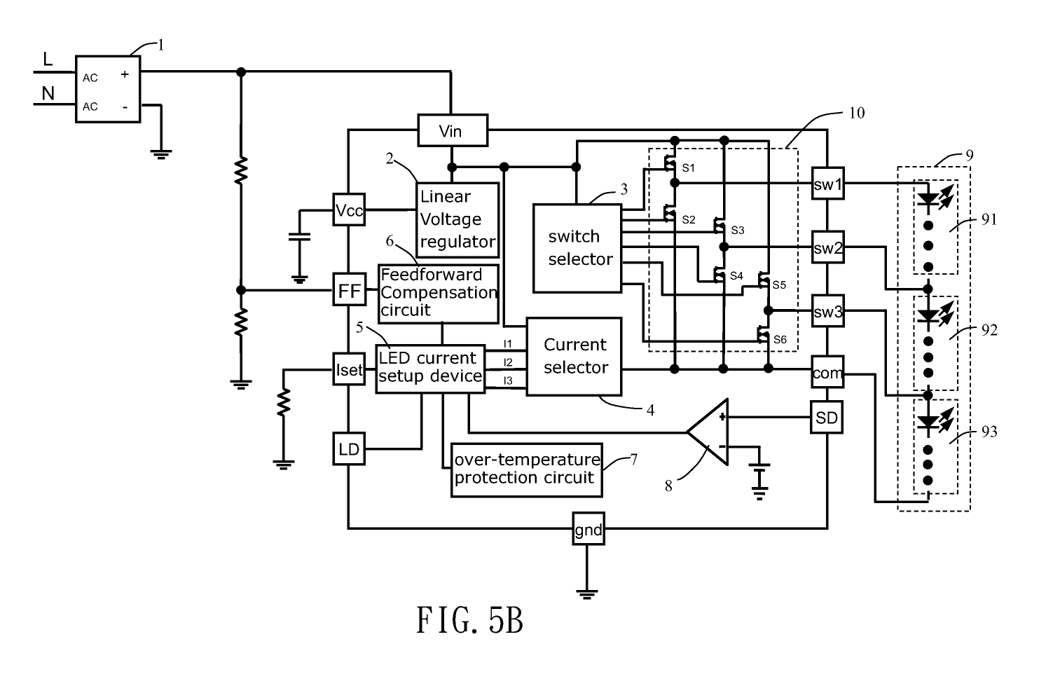

As shown in FIGS. 3C, 4 and 5B, it shows a control circuit module of light-emitting diode (LED) lamp having the detect points of Vcc, FF, Iset (LCD current set), LD, SW1, SW2, SW3 and a ground point. The control circuit module comprises: a AC to DC element is used for transferring mains AC power to DC power, and the AC to DC element consists of a full-bridge rectifier. The skilled person in the art also may use other elements to be the AC to DC element 1, but it is not limited in the present invention; a plurality of light diode groups 9 (the embodiments are the first, second and third groups of LCD 91, 92, 93), and each group comprises a plurality of serial connected light diodes or parallel connected light diodes; a plurality of switches 10 corresponding to the number of the groups is used for controlling light or off of the each group, and the plurality of switches 10 all consists of MOSFET; a linear voltage regulator 2 is used for cutting the DC power from the AC to DC element to a plurality of voltage sections (as shown in FIGS. 1A, 2A, 3A, 3B and 5A); a switch selector 3 is used for selecting the switches to turn on or turn off according to the voltage sections from the linear voltage regulator 2; and a current selector 4 is used for capturing available current sections (as shown in FIGS. 1A, 2A, 3A, 3B and 5A) from the voltage sections of the linear voltage regulator 2; and a LED current setup device 5 is used for controlling the current sections to turn on or turn off the plurality of switches 10 by a user according to the LED current setup device 5 and the current selector 4. In accordance with the set of the LCD current setup device, it may perform the program set to turn on one group in the plurality groups of LCD 9, a part of groups in the plurality groups of LCD 9 and all group in the in the plurality groups of LCD 9; a feedforward compensation circuit 6 transmits a current compensation signal to the LCD current setup device 5 to be a parameter after the feedforward compensation circuit 6 obtains the current signal of the detect point; a over-temperature protection circuit 7 lowers the current signal and the shutdown signal when the circuit is over temperature.

A control circuit module of light-emitting diode (LED) lamp further comprises: a shutdown detect point SD is used to enable circuit shutdown, the over-temperature protection, and the current value of short protection. The shutdown detect point SD is connected together with the plurality of switches 10, the feedforward compensation circuit 6 and the LCD current setup device 5, and a operational amplifier further located between the shutdown detect point SD and the LCD current setup device 5.

The operation principle of control circuit module of light-emitting diode (LED) lamp of the present invention as below:

1. The LCD current I_{LED} index uplifts with V_{F} (V_{F1}, V_{F2}, V_{F3}).

2. The SW1 is on and the maximum current of LCD is I₁ before the input voltage achieves V₁, and meanwhile the current of LED does not achieve I₁; when the voltage V_{ac} continuously increases and the current of LED is over than I₁, the current of LED is the constant current I₁.

3. The SW1 is off and the SW2 is on when the voltage V_{ac} achieves V₁, and meanwhile the first group of LED is serial connected with the second group of LED and the current is increased with the voltage V_{ac}, and the maximum current of the LED in this section is I₂; the SW2 is off when the voltage V_{ac} achieves V₂, and meanwhile the first group of LED is serial connected with the second group and the third group of LED, and the maximum current of the LED in this section is I₃; the SW2 is off and the SW1 is on when the voltage V_{ac} drops below the V₁, and meanwhile the current of LED in this section is I₁.

4. The entire current wave is similar as the square wave and the phase of the entire current wave is same as the voltage V_{ac}, so the power factor is high.

5. The structure of the present invention is separate more sections according to the V-I curve of the LED, resulting in the power factor and the efficiency are higher.

6. The current sections I₁, I₂, . . . may be represented by the step-square wave, the triangular wave, the oblique wave.

7. The input terminal of the AC to DC element is connected to one of a dimmer consisting of a bidirectional thyristor (Triac), a PWM or a linear dimmer to adjust the light so as to adjust the luminance according to the voltage change of the commercial voltage in the peak period and the off-peak period.

8. The feedforward compensation circuit may compensate the excessive average circuit flowing into the LED when the input voltage is higher.

9. By controlling the same pin to enable circuit shutdown, over-temperature protection, and short circuit protection.

In accordance with FIG. 1A through 5B, it may understand the control circuit module of light-emitting diode (LED) lamp provided by the present invention is mainly used for designing a control circuit module with high power factor and high-efficiency to control the plurality of groups of LED corresponding to the same groups of switches, and switch the DC current form the AC to DC element to the plurality of current sections. Subsequently, the control module may control the open and close of the plurality of switches according to each current section, and the plurality of switches control the plurality of groups of LED to turn on one group of LED, a part of groups of LED or all groups of LED, and control the same light time of each group of LED in the plurality of groups of LED in a period so as to achieve the purpose of the equal brightness of the LED lamp and balance the useful life of the plurality of groups of LED. Additionally, a detect shutdown point is set in the control circuit module, and the detect shutdown point is used to enable circuit shutdown, over-temperature protection and current value of short protection for avoiding the damage of the control circuit module and the LED because of the abnormal large current.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. A control circuit module of light-emitting diode (LED) lamp, comprising:
a AC to DC element, for transferring mains AC power to DC power;
a plurality of groups of LED, wherein each group comprises a plurality of serial connected LED/parallel connected LED;
a plurality of switches, corresponding to the number of the groups of LED, for controlling to turn on/off the each group;
a linear voltage regulator, for cutting the DC power from the AC to DC element to a plurality of voltage sections;
a switch selector, for selecting to open/close the switches according to the voltage sections from the linear voltage regulator;
a current selector, for capturing available current sections from the voltage sections of the linear voltage regulator; and
a LED current setup device, for controlling the current sections to open/close the plurality of switches by a user according to the LED current setup device and the current selector.

2. The control circuit module of claim 1, wherein the control circuit module of LED lamp further comprises a feedforward compensation circuit.

3. The control circuit module of claim 1, wherein the control circuit module of LED lamp further comprises an over-temperature protection circuit.

4. The control circuit module of claim 1, wherein the control circuit module of LED lamp further comprises a detect shutdown point, which is used to enable circuit shutdown, over-temperature protection and current value of short protection.

5. The control circuit module of claim 4, wherein the detect shutdown point is simultaneity connected with the plurality of switches, the feedforward compensation circuit and the LED current setup device.

6. The control circuit module of claim 1, wherein an operational amplifier is located between the detect shutdown points and the LED current setup device.

7. The control circuit module of claim 1, wherein the plurality of switches consists of MOSFET.

8. The control circuit module of claim 1, wherein the plurality of groups of LED turn on one group of LED, a part of group of LED or all group of LED according to the set of the LED current setup device.

9. The control circuit module of claim 1, wherein the control circuit module of LED lamp further comprises the AC to DC element consists of a full-bridge rectifier.

10. The control circuit module of claim 1, wherein an input terminal of the AC to DC element is connected to one of a dimmer consisting of a Triac, a PWM or a linear dimmer to adjust the light.

11. The control circuit module of claim 1, wherein the control circuit module of LED lamp further comprises detect points of Vcc, FF, Iset (LED current setup), LD, SW1, SW2, SW3 and a ground point.
